(19) United States
(12) Patent Application Publication
(10) Pub. No.: US 2014/0325185 A1
(43) Pub. Date: Oct. 30, 2014

(54) Method for Operating a Processor

(71) Applicants: Rene Graf, Zirndorf (DE); Wolfgang Hartmann, Aurachtal (DE)

(72) Inventors: Rene Graf, Zirndorf (DE); Wolfgang Hartmann, Aurachtal (DE)

(73) Assignee: Siemens Aktiengesellschaff, Muenchen (DE)

(21) Appl. No.: 14/364,138

(22) PCT Filed: Jan. 31, 2012
(86) PCT No.: PCT/EP2012/051483

§ 371 Date: Jun. 10, 2014

(51) Int. Cl. G06F 9/38

(52) U.S. Cl. CPC G06F 9/3867
USPC 712/42

(57) ABSTRACT

A method for operating a processor in which a first program comprising a first sequence of commands is provided, at least one second program is provided comprising a second sequence of commands, where the first program comprises a time-critical section with time-critical commands, commands from the first and second programs are processed in a processor pipeline, a start time is identified for the time-critical section in the first program, and a predefined interrupt program is incorporated into the at least one second program once the start time of the time critical section in the first program has been identified.

The present invention relates to a method for operating a processor. Moreover, the present invention relates to a processor. Finally, the present invention relates to an automation appliance having a processor.

Today, modern processors have more than one computation core and are referred to as multicore processors (MC) because they are able to execute multiple programs genuinely in parallel. In this case, each program runs on a separate processor core (core) and does not have to share the latter, with all of its subunits, such as floating point arithmetic unit (floating point unit, FPU), with any other program while it is running.

Even before the first multicore processors, there were approaches to nevertheless setting up a certain degree of parallelism without immediately providing an additional complete computation core besides the already existent one. This technique is known as hyperthreading (HT). In this context, a processor core comprises units that handle different tasks. Examples of these are the load storage unit (LSU), for example, which interchanges data between processor registers and memory, or the arithmetic logical unit (ALU), which is responsible for integer calculations.

These units are already able to operate in parallel to some extent even in a processor having one processor core, provided that the data are existent. It is thus possible for the ALU to operate with values in particular registers while the LSU loads other registers or transmits them to the memory. The processor has what is known as a pipeline internally in which the individual commands are executed in succession, with the individual stages of the pipeline depicting the various units in the processor. Usually, however, the units have to wait for one another, which means that the pipeline can be filled only to some extent and the theoretically possible computation power is not utilized. This restriction is largely lifted by the HT processors by simulating two or more processors for the operating system even though, internally, they have only portions of the additional processors available in multiple form.

By way of example, it is thus possible for two programs to operate effectively in parallel on a processor having one processor core (single-core processor). In this case, each program comprises a list of commands (instruction queue) that need to be executed in succession. In a single-core processor, the order is explicit and the runtime of the command chain is always the same even after an arbitrary number of passes. The programs run deterministically in this case. In an HT processor, on the other hand, the processor mixes the commands from the two available command lists internally in order to fill the pipeline as optimally as possible and to achieve the theoretically possible total computation power.

This is extremely successful in the case of many programs, the fact that not all units are existent in multiple form meaning that it is not possible to achieve twice or n times the power. In particular, complex units such as the FPU are normally available only once in the case of HT processors. If two programs that both operate floating point arithmetic are running in parallel, the HT processor is no faster than a normal single-core processor. Since this is usually rarely the case, however, an HT processor fundamentally allows an increase in computation power.

A drawback in this case, however, is that the runtime of one program is no longer predictable, since it is considerably dependent on the commands of the second program. When there are many passes, many different runtimes will therefore arise. Determinism plays no part in the case of standard operating systems (general purpose operating systems, GPOS), since in this case the programs do not have to accomplish their task from a particular time. In the area of realtime systems, which also involve the use of realtime operating systems (RTOS), the predictable runtime is an essential part of the application, however.

The aforementioned circumstance has prevented the use of HT processors for realtime systems. In many configurations, a nonrealtime application, such as a user interface, also runs besides the realtime application. The HT processors would provide an inexpensive alternative over genuine multicore processors in order to obtain higher computation powers at least for nonrealtime applications, but cannot be used on account of the massive time-related influences on the runtime of the realtime application.

Even genuine multicore computers still have certain restrictions as soon as further components, such as memory or peripherals, that are existent only once throughout the system and may therefore result in reciprocal blockades by the individual programs are used besides the processor, in which all units are existent in multiple form.

It is therefore an object of the present invention to demonstrate a way in which the power and reliability of a processor can be increased.

The invention achieves this object by means of a method for operating a processor according to patent claim 1. In the same way, this object is achieved by a processor according to patent claim 7 and by an automation appliance according to patent claim 10. Advantageous developments of the present invention are specified in the subclaims.

The method according to the invention for operating a processor comprises the provision of a first program having a first sequence of commands, the provision of at least one second program having a second sequence of commands, wherein the first program comprises a time-critical section having time-critical commands, the handling of the commands from the first and second programs in a processor pipeline, the identification of a starting instant for a time-critical section in the first program and the insertion of a previously stipulated interrupt program into the at least one second program as soon as the starting instant of the time-critical section in the first program is identified.

The term command is intended to be understood to mean particularly a machine command for the processor. The commands may be associated with the respective units of the processor. The term section denotes particularly a plurality of correlative commands. A program is intended to be understood to mean particularly a list of commands that is executed by the processor in order to achieve a particular functionality. In this case, the commands may be associated with corresponding sections.

In the present case, at least two programs that each comprise a sequence of commands are provided on a processor. These programs are also called instruction queues. The processor comprises at least two logic cores, each of the logic cores having an associated program. Hence, the processor is designed as a hyperthreading processor (HT processor). In the present case, the first program on the processor may comprise a time-critical section or time-critical commands or command sequences. The first program may thus comprise non-time-critical sections and time-critical sections.

The processor or an operating system embodied on a memory device of the processor is designed to identify a starting instant for the time-critical process in the first program. As soon as the starting instant of the time-critical process in the first program is identified, a previously stipulated interrupt program is inserted into the at least one second program. In other words, the section that is currently provided or handled on the at least second program is interrupted or stopped by an appropriate interrupt program. This interrupt program may contain a sequence of commands that are known or stipulated beforehand. Hence, the interrupt program is precisely predictable. The interrupt program preferably knows precisely which commands are performed and which portions of the processor are accessed in this case. Hence, a processor on which time-critical commands or sections are handled can also be made accessible to non-time-critical portions of a system without adversely influencing the time-critical processes in this case. The essential aspect of why the mixing of the sections or commands in a standard HT processor results in nondeterministic execution of a command list is the unpredictability of which command is in the other program in each case. The invention solves this problem by defining the commands or sections of the other programs that can still be handled in the case of a time-critical process sequence.

Preferably, starting of the time-critical section in the first program prompts an interrupt signal to be sent to the second program for the purpose of insertion of the interrupt program. The time-critical section or the time-critical sequence can generally be started by an interrupt, since the time-critical processor needs to react to an event. Such an event can, as one alternative, occur cyclically, for example under the control of a timer. Similarly, such an event can occur sporadically as a result of an alarm. The start of the time-critical section or the time-critical sequence in a first program then transmits an interrupt signal or an interrupt to the at least second program of the processor, the second program being seen as an independent and complete core from the point of view of the operating system. The interrupt program—which can also be called an interrupt service routine (ISR)—inserted in the second program then puts the second processor core into a defined state. Hence, in the case of a processor having at least two logic cores, the at least second logic core can be put into a defined state when a time-critical section is identified for the first logic core.

In one preferred embodiment, the time-critical section is handled together with the interrupt program in a predictable order in the processor pipeline. When a time-critical section is identified in the first program, a previously defined or stipulated interrupt program is inserted into the at least second program. Since this interrupt program, which can also be called an idle task, comprises known commands, the mixing with the unknown commands of the time-critical section in the processor pipeline nevertheless becomes explicit. This has the consequence that the same runtimes are always obtained particularly for multiple passes of the time-critical program.

The shutdown of the second or else of multiple logic cores or programs by means of the interrupt program allows the necessary determinism to be kept for the time-critical section. In addition, a higher throughput in comparison with a single-processor solution can be achieved with the described method when handling non-time-critical programs, since the non-time-critical programs can use more than one logic processor core when no time-critical section is currently being handled. When the time-critical section is not active, the non-time-critical programs can use the at least two logic cores of the HT processor. The nondeterministic mixing is irrelevant in this case, since the non-time-critical programs are rated according to their data throughput, which increases as a result of the parallel processing. Hence, the power of the entire processor or appliance can be increased without influencing reliability in this case.

Preferably, the interrupt program is also terminated with the time-critical section. Hence, the non-time-critical program is interrupted or shut down by the interrupt program only for such a period of time as the time-critical section requires for handling. Subsequently, a respective non-time-critical program can be handled again on both logic processor cores. Hence, the handling of the non-time-critical programs or commands on the processor can be speeded up.

In one embodiment, the interrupt program comprises the reading of a value from a memory, the comparison of the read value with a previously stipulated value and the restarting of the interrupt program if the read value and the stipulated value differ. In the interrupt program or the idle task, a value or a data item is first of all read from a previously stipulated memory cell. Subsequently, a comparison is performed to determine whether this value matches a previously stipulated value. If this is not the case, the value is read from the memory again and hence the routine is started afresh. These commands likewise define which units of the processor are used. This particularly involves the use of such units as are existent in the processor in multiple form or as befit the second program or the second logic core alone. By way of example, such units may be a load storage unit, which can load appropriate values from a memory. In addition, what is known as a compare unit can be used, which can compare appropriate values. As the memory cell from which the value is read, it is possible to use an internal memory cell of the processor, in particular. Hence, it is possible to prevent the physical main memory from being accessed during the interrupt program. Hence, the units of the processor that are used by the interrupt program are known. The other units are unrestrictedly available to the program or logic core that is used to handle the time-critical section. As a result, the runtime of the time-critical section or of the command list is not adversely influenced.

In one embodiment, the interrupt program is terminated by virtue of a value that corresponds to the previously stipulated value being written to the memory. During the interrupt program, a value can be read from an internal memory of the processor and can be compared with a previously stipulated value. So long as the time-critical section has not been terminated or executed, the previously stipulated value is not written to the memory. Only after the execution of the time-critical section is the previously stipulated value written to the memory. Hence, the routine of the interrupt program is also terminated. In this case, it is advantageous to choose a memory cell that is situated within the processor rather than in the physical main memory, so that the interrupt program or the idle task cannot take up singular resources such as memory connections or even bus systems. Hence, it is a simple matter to terminate the interrupt program, and the non-time-critical commands can accordingly be handled on the at least two programs or logic cores.

The processor according to the invention comprises a first processor unit for providing a first program having a first sequence of commands, at least one second processor unit for providing at least one second program having a second sequence of commands, wherein the first program comprises a time-critical section, a processor pipeline for handling the commands from the first and second programs, and a memory device having an operating system, wherein the processor is designed to execute the operating system and wherein the processor or the operating system is designed to identify the starting instant of the time-critical section in the first program and to insert a previously stipulated interrupt program into the at least one second program as soon as the starting time of the time-critical section in the first program has been identified.

Preferably, the processor comprises a data interchange unit and a comparison unit, wherein the data interchange unit is designed to read a value from a memory during the interrupt program and wherein the comparison unit is designed to compare the read value with a previously stipulated value during the interrupt program. Hence, it is possible to ensure that during the interrupt program only particular units of the processor are used. Preferably, such units as are available to the respective logic processor core or program alone are used. Similarly, an internal memory of the processor can preferably be used.

In a further embodiment, the processor comprises at least two processor cores. The previously described method for operating a processor can be used not only for HT processors but also for genuine multicore processors, in which all the cores have all the necessary units. In standard multicore processors, a nondeterministic behavior may arise even when there is a strict split of time-critical and non-time-critical programs that are associated with the respective processor cores, since both application elements access different system components such as memory or peripherals. Above all, the latter takes care of problems, even when the various applications use different peripherals, since the connection from processor having multiple cores to the multiple peripherals is set up via individual bus systems (usually PCI or PCIe). The possible reciprocal blockades that are caused thereby can be precluded by the method described.

A further advantage is the deterministic cache behavior that is likewise made possible by the method. Both in many multicore processors and in hyperthreading processors, multiple cores share the cache. If one of the programs or commands in a core cannot access the cache, but instead has to access the main memory, the overall execution time is slowed down considerably. If a defined interrupt program is operated when a time-critical section is executed on the at least one further program or core, the realtime application cannot be influenced by its cache behavior.

The automation appliance according to the invention comprises a processor as described previously. Automation appliances usually comprise two essential functions, the actual control of a physical process and the communication with the outside world. The communication can take place either by means of a user interface or via a network connection to an external operator control unit. The control of the physical processes usually requires defined time conditions to be observed, whereas during communication the mere inertia of the user means that provision has to be made for corresponding waiting times. The control function, which is usually a time-critical section, normally takes up only a small portion of the computation power of the processor. The control tasks should be able to be executed at any time, however. The communication programs usually take up a distinctly larger share of the computation power for the visualization of states or data interchange with other appliances. The use of the processor according to the invention means that distinctly more computation power can be made available to the communication programs. In addition, the processor can save costs.

The advantages and developments cited previously in connection with the method according to the invention can be transferred to the processor according to the invention and the automation appliance according to the invention in the same way.

The present invention will now be explained in more detail with reference to the appended drawings, in which:

FIG. 1 shows a schematic illustration of the program cycles in a hyperthreading processor;

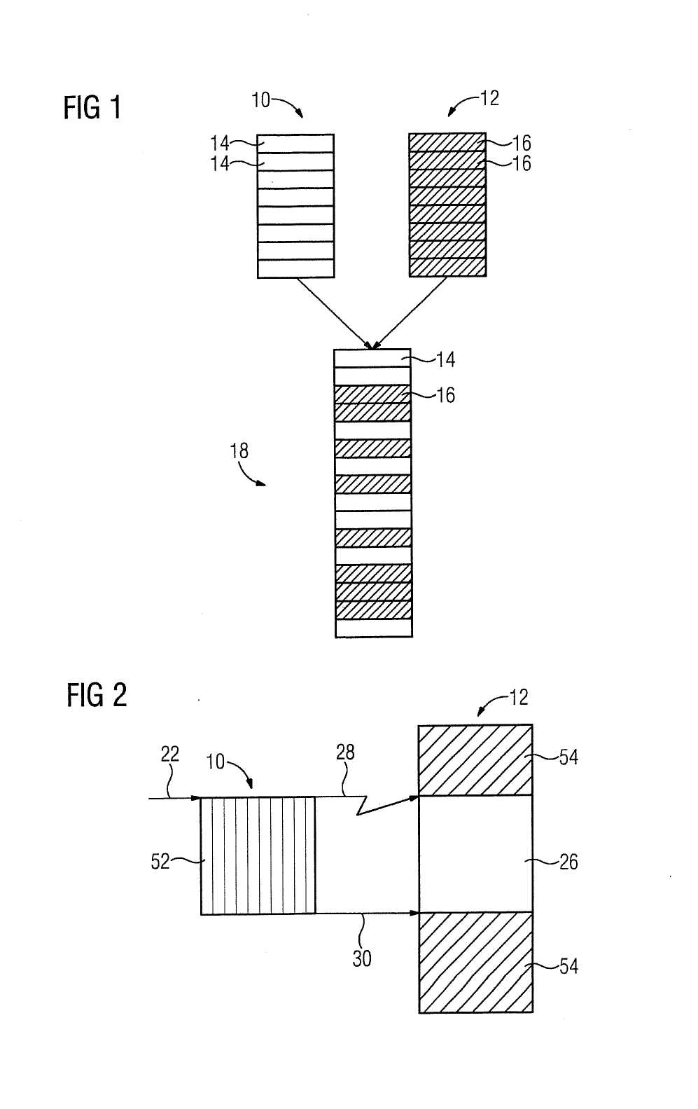

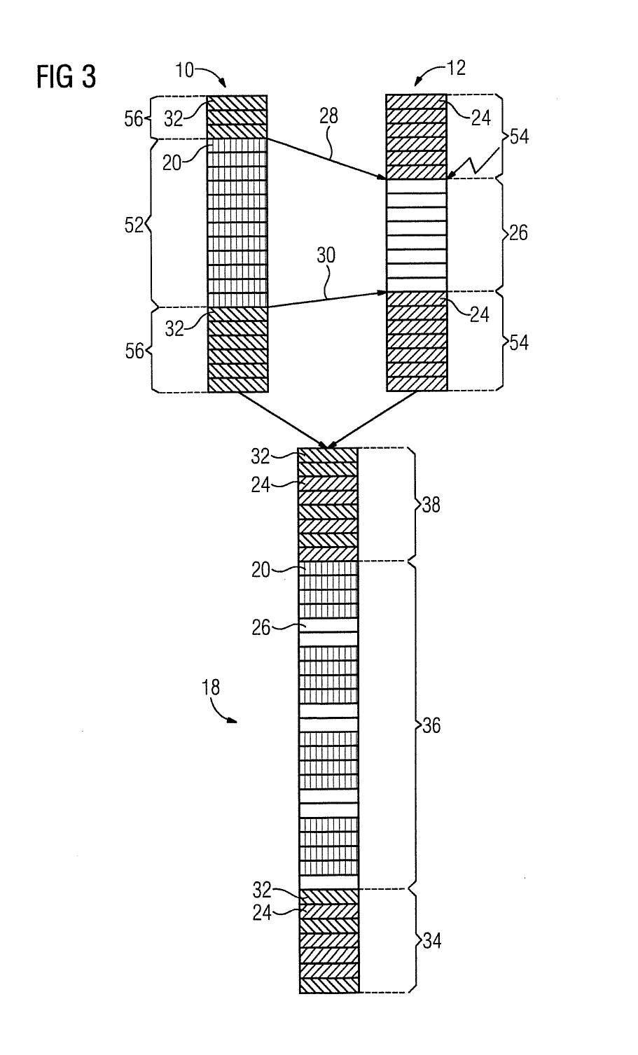

FIG. 2 shows a schematic illustration of the command arrangement for two programs, wherein the first program comprises a time-critical section;

FIG. 3 shows a schematic illustration of the command arrangement for two programs and for a processor pipeline;

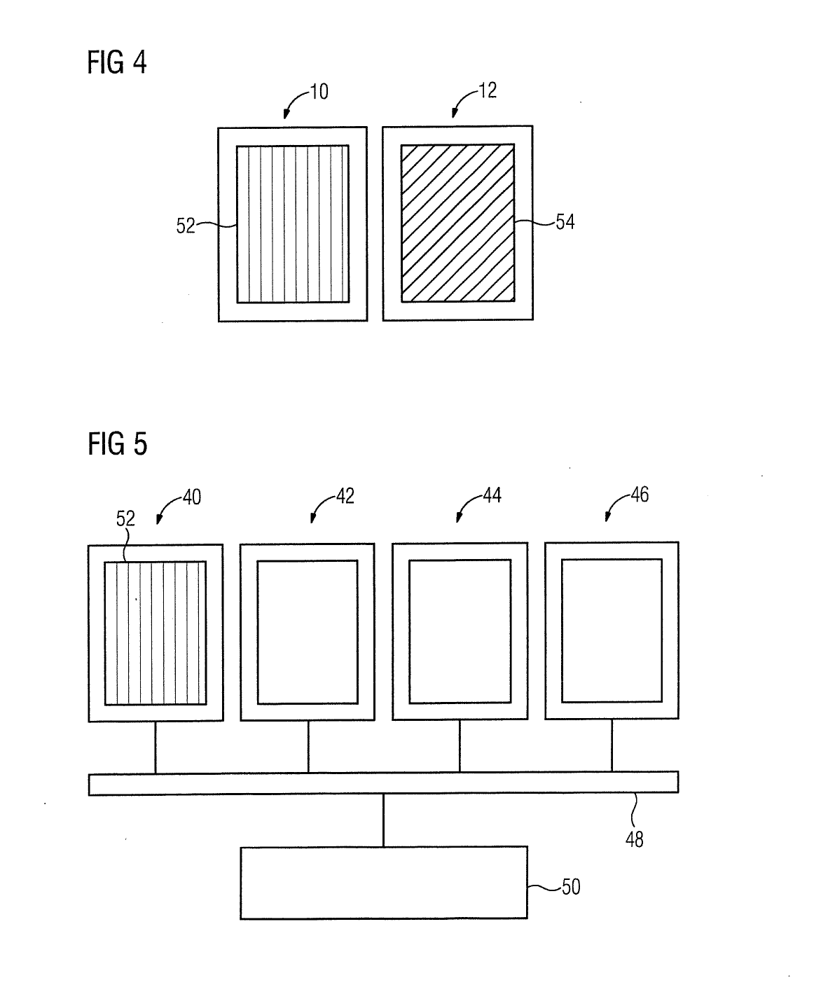

FIG. 4 shows a schematic illustration of a test arrangement; and

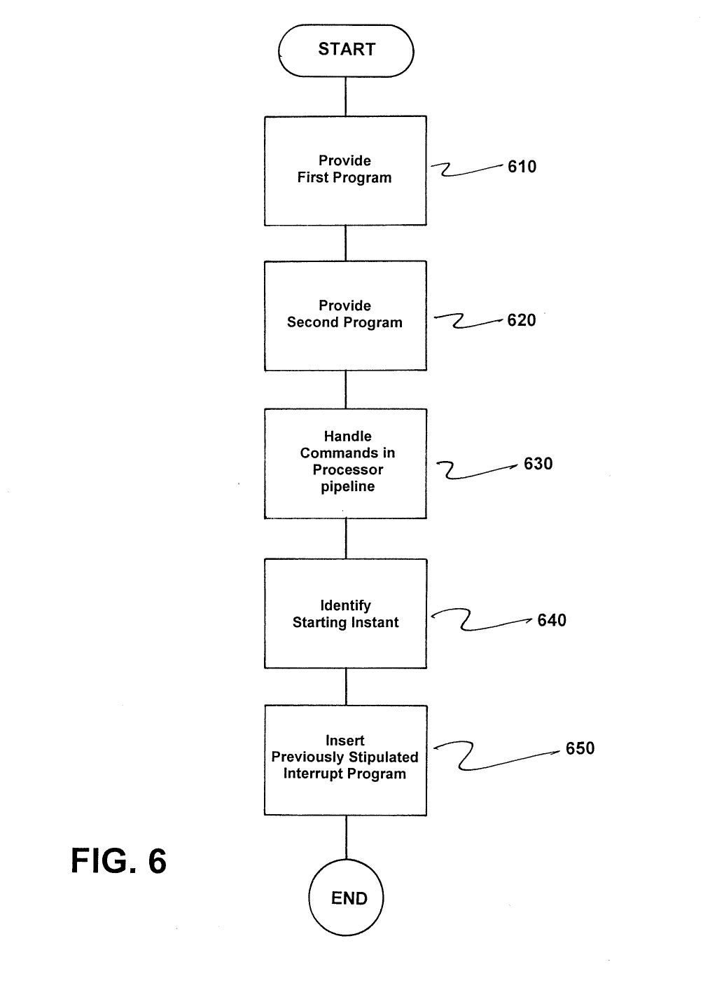

FIG. 5 shows a schematic illustration of a further test arrangement.

Exemplary embodiments that are outlined in more detail below are preferred embodiments of the present invention.

FIG. 1 shows a schematic illustration of the execution of the programs on a processor according to the prior art. Such a processor is called a hyperthreading processor. The processor comprises a processor core on which two processor units are provided, for example. Each processor unit is associated with a program in this case. In the present instance, a first program 10 and a second program 12 are operated on the processor. The first program 10 comprises a first sequence of commands 14 and the second program 12 comprises the second sequence of commands 16.

The order of the commands 14 in the first program 10 and of the commands 16 in the second program 12 are explicitly associated. Time-critical and non-time-critical sections can be handled in the first program 10 and in the second program 12. The commands 14 from the first program 10 and the commands 16 from the second program 12 are handled in the processor pipeline 18. The processor pipeline 18 has the commands 14 and 16 sorted and executed as appropriate. In this case, a nondeterministic and haphazard order for the first commands 14 and for the second commands 16 is obtained in the processor pipeline.

The first program 10 and the second program 12 can be regarded as logic processor cores, the processor comprising just one processor core. In this case, depending on the processor manufacturer, various units of the processor may be existent in single or multiple form. Usually, the units that perform simple computation tasks are present in multiple form, with more complex units being existent only in single form.

FIG. 2 shows a schematic illustration of two programs 10 and 12, the first program 10 comprising a time-critical section 52. A time-critical section 52 of this kind is usually started by an interrupt, since said time-critical section needs to react to an event. Such an event can occur cyclically or just sporadically, for example. The starting instant of the time-critical section 52 is denoted by the arrow 22. The second program 12 comprises a non-time-critical section 52.

The processor or operating system executed on a memory device of the processor is designed to identify the start or the starting instant of the time-critical section 52 in the first program. As soon as the starting instant of the time-critical section 52 in the first program 10 is identified, a previously stipulated interrupt program 26 is inserted into the second program 12.

When the time-critical section 52 is started, an appropriate interrupt signal or an interrupt is sent to the second program 12. The result of this is that the non-time-critical section 54 performed on the second program 12 is interrupted or an interrupt program 26 is inserted into the non-time-critical section 54. The interrupt that is transmitted from the first program 10 to the second program 12 is denoted by the arrow 28 in FIG. 2.

The interrupt program, which can also be called an idle task, may comprise the following steps:
reading of a value from a memory,
comparison of the read value with a previously stipulated one, and
restarting of the interrupt program if the read value and the stipulated value differ.

This command sequence likewise defines which units of the processor are used. In the present case, only the load storage unit and the compare unit are used. In addition, an internal memory of the processor is preferably accessed.

When the time-critical section 52 ends, the interrupt program 26 is also terminated. When the time-critical section 52 has been terminated, a write command writes the previously determined value to the memory cell that is permanently read by the interrupt program 26. This is shown by the arrow 30 in FIG. 2 by way of example.

FIG. 3 shows a schematic illustration of the handling of the commands in the first program 10, in the second program 12 and in the processor pipeline 18. The first program 10 comprises both non-time-critical sections 56 or commands 32 and time-critical sections 52 or commands 20. When the starting instant of a time-critical section 20 is identified in the first program 10, a previously defined interrupt program 26 is inserted into the second program 12. In this case, the non-time-critical section 24 currently being operated on the second program is interrupted or shut down.

The sections or commands 20, 24, 26, 32 from the programs 10 and 12 are handled in the processor pipeline 18.

Before a time-critical section 52 has been identified, the commands 24, 32 of the first program 10 and of the second program are executed in an unpredictable order and this command sequence is shown in the area 38 in the process pipeline 18. As soon as the starting point of a time-critical section 52 is identified, the interrupt program 26 is inserted into the second program. The interrupt program 26 comprises the previously defined steps. The joint execution of the time-critical section 52 from the first program and of the interrupt program 26 from the second program 12 results in a deterministic and predictable order for the commands 20, 26. This is shown in the area 36 in the processor pipeline. After the time-critical section 52 has been terminated, the interrupt program 26 is also terminated.

Subsequently, the non-time-critical sections 54, 56 from the first program 10 and the second program 12 are handled. This is shown by the area 34 in the processor pipeline 18.

FIG. 4 shows the schematic illustration of a test arrangement for the quantitative evaluation of the method according to the invention. In this case, a first program comprises a time-critical section 52. A second program 12 comprises a non-time-critical section 54. In a first test condition, the first program 10 and the second program 12 may each be associated with a logic core of a hyperthreading process. In a further test condition, the first program 10 and the second program 12 may each be associated with a processor core of a multicore processor.

In this test scenario, a floating point unit (FPU) is used for calculations. Such a floating point unit is existent only once in the case of an HT processor having two logic cores. Subsequently, the following test scenario is realized: the non-time-critical section 54 performs permanent calculations that require the FPU. The time-critical section 52 is triggered as appropriate and likewise performs calculations on the FPU. In this case, the time-critical section 52 measures the runtime for the calculations on the FPU.

The sections 52, 54 are in this case distributed over the two logic cores of an HT processor or an MC processor in a specific manner, as a result of which they fill the programs 10, 12 in parallel. The table below shows the measured values for the runtime of the time-critical section 52 in various test cases in which no measures have been taken in the operating system. For each measurement, 60 000 passes were made.

| | Minimum time | Mean time | Maximum time |
|---|---|---|---|
| | (μs) | (μs) | (μs) |
| Time-critical process | 839 | 839 | 1049 |
| alone on HT core | | | |
| Time-critical and | 880 | 1553 | 1736 |
| non-time-critical | | | |
| processes on one HT | | | |
| core each | | | |
| Time-critical process | 838 | 838 | 842 |
| alone on MC core | | | |
| Time-critical and | 839 | 839 | 844 |
| non-time-critical | | | |
| processes on one MC | | | |
| core each | | | |

The times in row 2 very clearly show the effect in the case of the HT processor that the execution times on the logic core of the processor on which the time-critical section 52 runs are greatly increased when an FPU application likewise runs on the other core. In the worst case, even twice the time is needed, which is the case when both logic cores of the HT processor are reliant on the FPU in parallel. On a genuine multicore processor, on the other hand, the two sections 52, 54 on the two logic cores do not influence one another at all, which was likewise to be expected.

The table below implements the method according to the invention, in which the second core or logic core is sent an interrupt program or an idle task by interrupt, so that collisions should not occur.

| | Minimum time | Mean time | Maximum time |
|---|---|---|---|
| | (μs) | (μs) | (μs) |
| Time-critical process | 889 | 889 | 890 |
| alone on HT core | | | |
| Time-critical and | 888 | 888 | 890 |
| non-time-critical | | | |
| processes on one HT | | | |
| core each | | | |
| Time-critical process | 843 | 843 | 848 |
| alone on MC core | | | |
| Time-critical and | 843 | 843 | 848 |
| non-time-critical | | | |
| processes on one MC | | | |
| core each | | | |

As the measured values clearly show, the times remain very constant in this case. They are slightly increased in comparison with the values above, owing to the additional mechanism, in the case of which an interrupt program 26 is additionally handled. In return, in the first row even the poorest times are better than in the table shown above, since any influencing by programs on another logic core is prevented.

In summary, it can be stated that the method according to the invention works and makes a significant contribution to improving the determinism of the time-critical sections. In the times in which the time-critical section 52 is not running, the previous power is available for the other cores.

A further important aspect besides the reciprocal influencing of the logic cores of an HT processor is also the access operations on the peripherals, since these operations can disturb the time-critical sections or applications in sensitive fashion, since collisions on a bus system can likewise result in unpredictable delays. In a further test scenario, a PCI card that cyclically produces interrupts at intervals of one millisecond was provided in a computer. The relevant interrupt service routine (ISR) performs various time measurements and sends a signal to the application, which is therefore continued. In this case, the ISR executes a write command on the PCI card.

The test scenario is shown schematically in FIG. 5. In this case, a multicore processor comprised four cores 40, 42, 44 and 46, and the time-critical program 10, including the ISR, runs in the first core 40 of the multicore processor, while on each of the other three cores 42, 44, 46 an appropriate application permanently effects read access to a PCI card 50 via a PCI bus 48.

The table below shows the measured values that arise when the system runs as described. Overall, 60 000 cycles were executed in order to obtain statistical statements.

| | Minimum time | Mean time | Maximum time |
|---|---|---|---|
| | (ns) | (ns) | (ns) |
| ISR latency | 6960 | 9210 | 10 580 |
| PCI read command | 1040 | 2007 | 2147 |
| PCI write command | 12 | 14 | 18 |
| Overall ISR duration | 3910 | 6010 | 6533 |

The use of the method according to the invention results in the measured values in the table below. In this case, 60 000 cycles were likewise executed.

| | Minimum time | Mean time | Maximum time |
|---|---|---|---|
| | (ns) | (ns) | (ns) |
| ISR latency | 5020 | 6042 | 7200 |
| PCI read command | 899 | 948 | 995 |
| PCI write command | 12 | 13 | 30 |
| Overall ISR duration | 2649 | 3561 | 4083 |

The times for the ISR latency are improved by 30% on average, which can be attributed to reduced bus loading. The PCI read access operations are distinctly more stable and are now barely subject to any fluctuations as a result of the method according to the invention, whereas previously the worst times were approximately 100% above the best. As expected, the PCI write access operations are not extended at all, since in this case writing only ever takes place in a buffer. The time that this value requires until it has arrived in the register of the PCI card ought likewise to be significantly improved or stabilized, however, which has not been established, however. The runtime of the ISR as a whole likewise decreases by over 30% on average.

### LIST OF REFERENCE SYMBOLS

10 Program
12 Program
14 Command
16 Command
18 Processor pipeline
20 Command
22 Arrow
24 Section
26 Interrupt process
28 Arrow
30 Arrow
32 Section
34 Area
36 Area
38 Area
40 Processor core
42 Processor core
44 Processor core
46 Processor core
48 PCI bus
50 PCI card
52 Section
54 Section
56 Section

1.-10. (canceled)

11. A method for operating a processor comprising:
providing a first program having a first sequence of commands to the processor;
providing at least one second program having a second sequence of commands to the processor, the first program comprising a time-critical section having time-critical commands; and
handling commands from the first and second programs in a processor pipeline;
identifying a starting instant for the time-critical section in the first program; and
inserting a previously stipulated interrupt program into the at least one second program as soon as the starting instant of the time-critical section in the first program is identified.

12. The method as claimed in claim 11, wherein starting of the time-critical section in the first program prompts an interrupt signal to be sent to the second program for insertion of the interrupt program.

13. The method as claimed in claim 11, wherein the time-critical section is handled together with the interrupt program in a predictable order in the processor pipeline.

14. The method as claimed in claim 12, wherein the time-critical section is handled together with the interrupt program in a predictable order in the processor pipeline.

15. The method as claimed in claim 11, wherein the interrupt program is also terminated with the time-critical section.

16. The method as claimed in claim 11, wherein the interrupt program comprises:
program instructions for reading of a value from a memory,
program instructions for comparing the read value with a previously stipulated value; and
program instructions for restarting the interrupt program if the read value and the stipulated value differ.

17. The method as claimed in claim 15, wherein the interrupt program is terminated by virtue of a value that corresponds to the previously stipulated value being written to the memory.

18. The method as claimed in claim 16, wherein the interrupt program is terminated by virtue of a value that corresponds to the previously stipulated value being written to the memory.

19. A processor comprising:
a first processor unit for providing a first program having a first sequence of commands;
at least one second processor unit for providing at least one second program having a second sequence of commands, the first program comprising a time-critical section having time-critical commands;
a processor pipeline for handling commands from the first and second programs; and
a memory device having an operating system, the processor being configured to execute the operating system;
wherein one of the processor and the operating system is configured to identify a starting time for the time-critical section in the first program and to insert a previously stipulated interrupt program into the at least one second program as soon as the starting time of the time-critical section in the first program has been identified.

20. The processor as claimed in claim 19, further comprising:
a data interchange unit configured to read a value from a memory during the interrupt program; and
a comparison unit configured to compare the read value with a previously stipulated value during the interrupt program.

21. The processor as claimed in claim 19, wherein the processor comprises at least two processor cores.

22. The processor as claimed in claim 20, wherein the processor comprises at least two processor cores.

23. An automation appliance having the processor as claimed in claim 19.
